(19) United States
(12) Patent Application Publication
(10) Pub. No.: US 2004/0193605 A1
(43) Pub. Date: Sep. 30, 2004

(54) Control of access to computers in a computer network

(76) Inventors: Mitchell T. Weisman, San Carlos, CA (US); Mark E. Pennell, Austin, TX (US)

Correspondence Address: OKAMOTO & BENEDICTO, LLP, P.O. BOX 641330, SAN JOSE, CA, 95164, US

(21) Appl. No.: 10/434,405

(22) Filed: May 8, 2003

Related U.S. Application Data
(60) Provisional application No. 60/457,391, filed on Mar. 25, 2003.

(51) Int. Cl. G06F 17/30

(52) U.S. Cl. 707/9

(57) ABSTRACT

In one embodiment, an access indicator set in a client computer contains information for gaining access to a sever computer in a computer network. The access indicator may be a cookie, while the server computer may be hosting a website on the Internet. The client computer may provide the contents of the access indicator to the server computer as a pass for gaining access to a particular section or entirety of the server computer. In one embodiment, setting of the access indicator is initiated by a computer program resident in the client computer. The non-web browser computer program may periodically initiate the setting of the access indicator to prevent it from expiring. In one embodiment, access privileges in a website are only provided to end-users who explicitly agree to receive advertisements.

### CROSS-REFERENCE TO RELATED APPLICATION

The present application claims the benefit of U.S. Provisional Application No. 60/457,391, entitled “CONTROL OF ACCESS TO COMPUTERS IN A COMPUTER NETWORK”, filed by Mitchell T. Weisman and Mark E. Pennell on Mar. 25, 2003.

### BACKGROUND OF THE INVENTION

1. Field Of The Invention

The present invention relates generally to computer systems, and more particularly but not exclusively to methods and associated systems for controlling access to computers in a computer network.

2. Description Of The Background Art

As is well known, a website may be hosted in a server computer accessible over the Internet. A website may include contents such as news, products for sale, on-line services, video, audio, and other information. Just like in other media, a website may also contain advertisements to cover the cost of operating the website. For example, a web page provided to a client computer may also include banner advertisements.

As the quality and sophistication of content offered by websites increase, so does the cost of operating the websites. This prompted some websites to control access to all or some of their contents. For example, some websites require end-users to provide their e-mail address or demographic information before being allowed access to the website. Provided e-mail address may be used in an advertising campaign, while demographic information may be used to tailor advertisements displayed to end-users—both of which may help a website attract more advertisers and thereby increase its revenue.

Another way to control access to a website is to charge a subscription fee. End-users who subscribe are given a password that allows them to gain access to the website or member-only sections of the website. For example, end-users who subscribe may be able to receive streaming video or access an on-line database, whereas those who do not may only be allowed access to public sections of the website.

### SUMMARY

The present invention relates to methods and associated systems for controlling access to computers in a computer network. The present invention may be used in a variety of applications, including controlling access to one or more websites on the Internet.

In one embodiment, an access indicator set in a client computer contains information for gaining access to a sever computer in a computer network. The access indicator may be a cookie, while the server computer may be hosting a website on the Internet. The client computer may provide the contents of the access indicator to the server computer as a pass for gaining access to a particular section or the entirety of the server computer. In one embodiment, setting of the access indicator is initiated by a computer program resident in the client computer. The computer program may periodically initiate the setting of the access indicator to prevent it from expiring. In one embodiment, access privileges in a website are only provided to end-users who explicitly agree to receive advertisements.

These and other features of the present invention will be readily apparent to persons of ordinary skill in the art upon reading the entirety of this disclosure, which includes the accompanying drawings and claims.

### DESCRIPTION OF THE DRAWINGS

FIG. 1 shows a schematic diagram of a computer network in accordance with an embodiment of the present invention.

FIG. 2 shows a flow diagram schematically illustrating control of access to a computer in a computer network, in accordance with an embodiment of the present invention.

FIG. 3 shows a flow diagram of a method of controlling access to a computer in a computer network, in accordance with an embodiment of the present invention.

FIG. 4 shows a flow diagram of a method of setting an access indicator, in accordance with an embodiment of the present invention.

The use of the same reference label in different drawings indicates the same or like components.

### DETAILED DESCRIPTION

In the present disclosure; numerous specific details are provided such as examples of apparatus, components, and methods to provide a thorough understanding of embodiments of the invention. Persons of ordinary skill in the art will recognize, however, that the invention can be practiced without one or more of the specific details. In other instances, well-known details are not shown or described to avoid obscuring aspects of the invention.

It is to be noted that although embodiments of the present invention are described herein in the context of the Internet, the present invention is not so limited and may be used in other data processing applications.

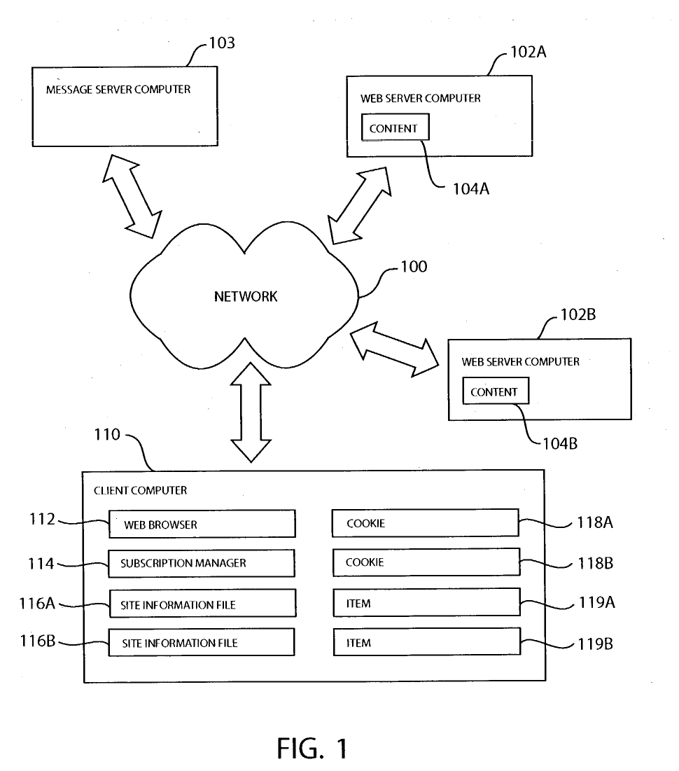

Referring now to FIG. 1, there is shown a schematic diagram of a computer network 100 in accordance with an embodiment of the present invention. Network 100 may include one or more client computers 110, one or more web server computers 102 (i.e., 102A, 102B, . . . ), one or more message server computers 103, and other computers not shown. Intermediate nodes such as gateways, routers, bridges, Internet service provider networks, public-switched telephone networks, proxy servers, firewalls, and other network components are not shown for clarity. In the example of FIG. 1, network 100 includes the Internet; however, other types of computer networks may also be used. Computers may be coupled to network 100 using any type of connection without detracting from the merits of the present invention.

A client computer 110 is typically, but not necessarily, a personal computer such as those running the Microsoft Windows™, Apple Macintosh™, Linux, or UNIX operating systems. An end-user may employ a suitably equipped client computer 110 to get on network 100 and access computers coupled thereto. For example, a client computer 110 may be used to access a content 104 (i.e., 104A, 104B, . . . ) from a web server computer 102 if the client computer 110 has the appropriate access privileges.

It is to be noted that as used in the present disclosure, the term “computer” includes any type of data processing device including personal digital assistants, digital telephones, wireless terminals, video game consoles, and the like. It is to be further noted that for purposes of the present disclosure, a computer may be a single computer or a network of computers. For example, a server computer hosting a website may comprise a single server computer, or several server computers in communication with one another.

A web server computer 102 may host a website containing information designed to attract end-users surfing on the Internet. A web server computer 102 may also include one or more contents 104, such as web pages, downloadable computer programs, products available for online purchase, voice, video, audio, wallpapers, on-line services, and the other types of information, data, or service accessible over a computer network. A web server computer 102 may also be an ad server for delivering advertisements to a client computer 110. For example, a web server computer 102 may serve banner advertisements to a web page received in a client computer 110.

In the context of the present disclosure, “accessing a website” is the same as “accessing the web server computer hosting the website”. Thus, a client computer having access privileges in a web server computer means that the end-user of that client computer has access privileges in the website hosted by that web server computer.

A message server computer 103 may include the functionalities of a web server computer 102. Additionally, in one embodiment, a message server computer 103 may also include downloadable computer programs and files for supporting, updating, or maintaining components in a client computer 110. Specifically, a message server computer 103 may include site information files 116 (i.e., 116A, 116B, . . . ) and subscription manager 114 that may be downloaded to a client computer 110. Site information files 116, subscription manager 114, and other components of a client computer 110 are further discussed below.

Examples of message server computers that may be adapted to work with embodiments of the present invention include those disclosed in the following commonly-assigned disclosures, which are incorporated herein by reference in their entirety: U.S. application Ser. No. 10/152,204, entitled “METHOD AND APPARATUS FOR DISPLAYING MESSAGES IN COMPUTER SYSTEMS”, filed by Scott G. Eagle, David L. Goulden, Anthony G. Martin, and Eugene A. Veteska on May. 21, 2002; and U.S. application Ser. No. 10/289,123, entitled “RESPONDING TO END-USER REQUEST FOR INFORMATION IN A COMPUTER NETWORK”, filed by Eugene A. Veteska, David L. Goulden, and Anthony G. Martin on Nov. 05, 2002. The just mentioned commonly-assigned disclosures are referenced herein as examples and not limitations, as other types of server computers may be employed without detracting from the merits of the present invention.

Web server computers 102 and message server computers 103 are typically, but not necessarily, server computers such as those available from Sun Microsystems, Hewlett-Packard, and International Business Machines. A client computer 110 may communicate with a web server computer 102 or a message server computer 103 using client-server protocol. It is to be noted that client-server computing is well known in the art and will not be further described here.

FIG. 1 also shows some of the components of a client computer 110 in accordance with an embodiment of the present invention. In one embodiment, the components of client computer 110 shown in FIG. 1 are implemented in software. It should be understood, however, that components in the present disclosure may be implemented in hardware, software, or a combination of hardware and software (e.g., firmware). Software components may be in the form of computer programs comprising computer-readable program code stored in a computer-readable storage medium such as random access memory (RAM), mass storage device (e.g., local hard disk drive or remote hard disk drive accessible over the Internet), or removable storage device (e.g., optical storage device such as a CD-ROM or DVD). For example, a computer-readable storage medium may comprise computer-readable program code for performing the function of a particular component. Likewise, computer memory may be configured to include computer-readable program code for a particular component, which may be executed by a microprocessor. Components may be implemented separately in multiple modules or together in a single module.

Still referring to FIG. 1, a client computer 110 may include a web browser 112, a subscription manager 114, one or more site information files 116 (i.e., 116A, 116B, . . . ), one or more cookies 118 (i.e., 118A, 118B, . . . ), and one or more items 119 (i.e., 119A, 119B, . . . ). Hardware and software components not relevant to the present invention are omitted in the interest of clarity.

Web browser 112 may comprise computer-readable program code for accessing contents of a web server computer 102. Web browser 112 enables an end-user to browse and navigate over the Internet. Web browser 112 may be a commercially available web browser or web client. In one embodiment, the Microsoft Internet Explorer™ web browser is employed in a client computer 110 as web browser 112. For purposes of the present disclosure, any computer program that is not generally used by an end-user for browsing and navigation is also referred to as a “non-web browser” computer program. An example non-web browser computer program includes subscription manager 114 discussed below.

Subscription manager 114 may comprise computer-readable program code for communicating with message server computer 103. Subscription manager 114 may communicate with message server computer 103 over a TCP/IP connection, for example. Subscription manager 114 and message server computer 103 may exchange data using conventional client-server protocol. Message server computer 103 may thus provide site information files 116 to client computer 110. Similarly, subscription manager 114 may provide statistical information to message server computer 103. Examples of statistical information include the addresses (e.g., URL's) of websites visited by the end-user and the advertisements the end-user clicked on. It is to be noted that the mechanics of monitoring an end-user's browsing activity, such as determining where an end-user is navigating to, what an end-user is typing on a web page, when an end-user activates a mouse or keyboard, and the like, is, in general, known in the art and is not further described here. For example, subscription manager 114 may determine where web browser 112 is pointed to by listening for event notifications.

Subscription manager 114 may also comprise computer-readable program code for initiating the setting of a cookie 118. Subscription manager 114 may initiate the setting of a cookie 118 by having it created if it is not already in client computer 110, or by having it updated. As will be more apparent below, each web server computer 102 that has provided client computer 110 with access privileges has a corresponding cookie 118. That is, cookie 118A may be for indicating access privileges in web server computer 102A, cookie 118B may be for indicating access privileges in web server computer 102B, and so on. Subscription manager 114 may initiate the setting of cookie 118A after client computer 110 is provided access privileges in web server computer 102A. Similarly, subscription manager 114 may initiate the setting of cookie 118B after client computer 110 is provided access privileges in web server computer 102B.

Subscription manager 114 may initiate the setting of a cookie 118 by sending commands to web browser 112. In one embodiment where web browser 112 comprises the Microsoft Internet Explorer™ web browser, subscription manager 114 initiates the setting of a cookie 118 using the WinInet.dll API (application programming interface) InternetSetCookie( ). In the same embodiment, subscription manager 114 receives the contents of a cookie 118 from web browser 112 using the WinInet.dll API InternetGetCookie( ). When setting a cookie 118, subscription manager 114 tells web browser 112 the website the cookie is for and the expiration date of the cookie. Subscription manager 114 may also specify a pass-code expressed as a name-value pair to be included in a cookie 118. A pass-code allows a website to distinguish a cookie 118, which as described below may serve as an access indicator, from other cookies for that website. The pass-code may also indicate a level of access privilege (e.g., basic, premium). Web browser 112 stores a cookie 118 in accordance with the file naming and location conventions of the specific web browser and operating system employed in client computer 110.

A cookie is 118 may be set with a relatively short expiration time (e.g., 24 hours) so that it will expire if subscription manager 114 does not periodically tell web browser 112 to set it. In one embodiment, subscription manager 114 periodically initiates the setting of one or more cookies 118 as long client computer 110 meets one or more requirements. An example requirement includes having a site information file 116, an item 119, or both in client computer 110. Item 119 may be a computer file, a computer program, a piece of hardware (e.g., peripheral card plugged in a bus), or other types of computer component. As can be appreciated, an item 119 may be any component whose presence is detectable in client computer 110.

An item 119 may also be a computer program for delivering messages to client computer 110. For example, an item 119 may be a computer program for initiating reception of advertisements from message server computer 103 or an ad server on the Internet. In essence, client computer 110 may be allowed access to a particular web server computer 102 in exchange for the right to deliver advertisements to client computer 110; revenue from the advertisements may be used to help pay for the cost of operating the web server computer 102. Example computer programs for delivering messages to client computer 110 include message delivery programs disclosed in the above-referenced commonly-assigned disclosures. These message delivery programs are merely provided as examples, as other means for receiving advertisements in client computer 110 may be employed without detracting from the merits of the present invention.

In one embodiment, a cookie 118 serves as an access indicator. That is, a web server computer 102 may receive the contents of a cookie 118 to determine if client computer 110 has access privileges. For example, a web server computer 102 may expect a cookie 118 to contain a pass-code, such as a name-value pair “SitePass=SitepassMgr”, before providing access.

It is to be noted that cookies, in general, are known in the art and described in the Internet Engineering Task Force (IETF) document RFC 2109. In one embodiment of the present invention, setting of cookies 118 is initiated by subscription manager 114, instead of a web server computer 102. This advantageously allows subscription manager 114 to control access to several, different web server computers 102 by initiating the setting of corresponding cookies 118 (note that a web server computer 102 may only initiate the setting of its own cookies, while web browser 112 normally does not set cookies unless requested). As an economic benefit, this advantageously allows one business entity (e.g., individual, corporation, etc.), which may be the provider or creator of subscription manager 114, to promote, manage, and control access to several web server computers. That business entity may charge the operators of participating web server computers 102 for its services.

As mentioned, a site information file 116 may be downloaded from message server computer 103. A site information file 116 may also be downloaded from a web server computer 102. In one embodiment, a site information file 116 is a text file containing configuration information for a web server computer 102. In the example of FIG. 1, site information file 116A contains configuration information for web server computer 102A, site information file 116B contains configuration information for web server computer 102B, and so on. As a specific example, site information file 116A may have the following configuration information for web server computer 102A:

“[sitepass] domain=toonland.com FriendlyName=Toonland.com website RefreshIntervalHrs=1”

to indicate that the cookie for the domain name “toonland.com”, also known as the “Toonland.com website”, is to be updated every 1 hour. Subscription manager 114 may then tell web browser 112 to set cookie 118A for “toonland.com” with an expiration time of at least 1 hour. Subscription manager 114 may then periodically initiate setting of cookie 118A every hour.

In light of the present disclosure, those of ordinary skill in the art will appreciate that using subscription manager 114 to control access to web server computers 102 provides advantages heretofore unrealized. In addition to being able to control access to several web server computers, subscription manger 114 is also uniquely capable of determining whether client computer 110 is meeting a requirement. Specifically, because of security provisions in most web browsers, a typical web server computer 102 is not capable of detecting whether an item 119 remains in client computer 110. In contrast, subscription manager 114, being a client computer program, can determine if an item 119 remains in client computer 110 by performing a file search, for example. This ensures that an end-user who is provided access to a website in exchange for the promise to retain an item 119 (which may be an advertisement or a computer program for receiving advertisements) in client computer 110 actually does so. Subscription manager 114 will not initiate the setting of a corresponding cookie 118 if it detects that the required item 119 is no longer in client computer 110, thereby causing cookie 118 to expire and revoking the end-user's access privileges in the website.

In one embodiment, subscription manager 114 has its own program group, uninstall, and icon in client computer 110. This readily allows an end-user to find where subscription manager 114 is located and, if necessary, use the uninstall to remove subscription manager 114 and associated files, such as site information files 116. Preferably, the end-user is provided the option to uninstall individual site information files 116, to be able to cancel membership in specific websites. Program groups, uninstalls, and icons are well known components of client computers running the Microsoft Windows™ operating system.

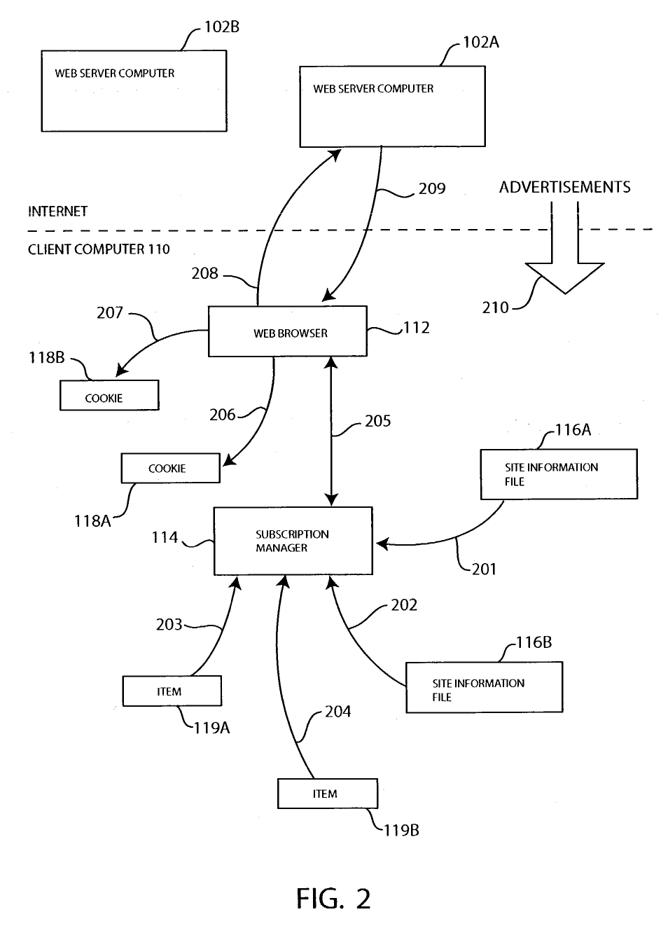

FIG. 2 shows a flow diagram schematically illustrating control of access to a computer in a computer network, in accordance with an embodiment of the present invention. As indicated by arrows 201 and 202, subscription manager 114 reads site information files 116 available in client computer 110 to determine how to configure cookies 118. Thereafter, subscription manager 114 detects for the presence of item 119A, item 119B, or both in client computer 110 (see arrows 203 and 204). In this example, the presence of item 119A, item 119B, or both is a requirement for accessing all or certain sections of web server computer 102A. The requirement for accessing a web server computer 102 may be obtained from a corresponding site information file 116. For example, the requirement to have item 119A to access web server computer 102A may be stored in site information file 116A.

Subscription manager 114 tells web browser 112 (see arrow 205) to set cookies 118 based on configuration information obtained from corresponding site information files 116. Cookie 118A is set (see arrow 206) in accordance with configuration information obtained from site information file 116A, cookie 118B is set (see arrow 207) in accordance with configuration information obtained from site information file 116B, and so on. In this example, subscription manager 114 initiates the updating of cookie 118A every hour to prevent it from expiring. When web browser 112 sends an access request to web server computer 102A (see arrow 208), web browser 112 uploads the contents of all cookies intended for web server computer 102A along with the access request. The uploaded contents include those of cookie 118A, which web server computer 102A examines to determine if client computer 110 has any access privileges. Based on the contents of cookie 118A, web server computer 102A provides a response (see arrow 209) to client computer 110. The response may include a web page, a multi-media file, access to an on-line database, streaming video, a voice-over-IP connection, etc.

A web server computer 102 may restrict access to all sections or certain sections of the web server computer 102. For example, web server computer 102A may host a website that only allows access to end-users with access privileges. The website may also have public sections and member-only sections. The public sections may provide “basic services” such as capability to view web pages that contain general information, while the member-only sections may provide “premium services” such as capability to view streaming video, listen to MP3 music, or view web pages containing special information (e.g., stock market tips). Cookie 118A may indicate the kind of service a client computer 110 (and hence the end-user) is authorized to access.

As indicated by arrow 210, advertisements may be delivered in client computer 110 so long as it retains access privileges in web server computer 102A, web server computer 102B, or both. The advertisements may be incorporated in web pages provided by web server computer 102A. In the example of FIG. 2, the requirement for allowing access to web server computer 102A includes retaining item 119A, which may be a client computer program for receiving advertisements from an ad server (not necessarily web server computer 102A) over the Internet. However, the requirement may also simply be keeping subscription manager 114, site information file 116A, or both in client computer 110.

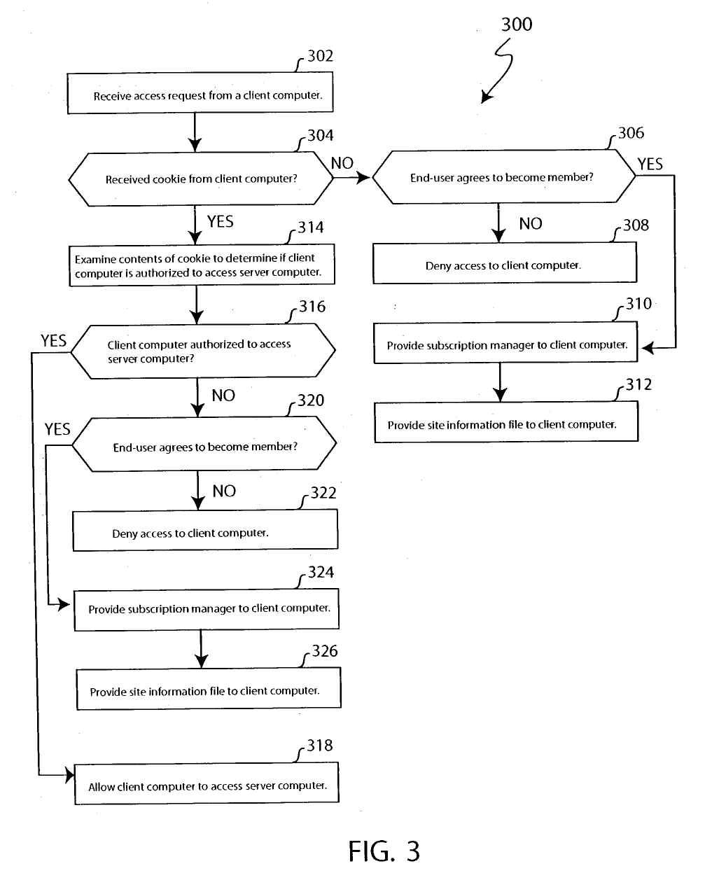

FIG. 3 shows a flow diagram of a method 300 for controlling access to a computer in a computer network, in accordance with an embodiment of the present invention. Method 300 describes the steps performed by a web server computer. As can be appreciated, method 300 may also be re-written to describe the steps performed by a client computer. For example, web server computer steps that recite “receiving” may be re-written to recite “sending” to describe corresponding steps performed by a client computer.

Starting in step 302, a web server computer receives an access request from a client computer. The access request may be a request to download a document, such as a web page or a file, or access a service, for example. In step 304, the web server computer determines if a cookie serving as an access indicator has been received from the client computer. Not receiving a cookie from the client computer indicates that the end-user of the client computer is not a registered member, and is thus not authorized to access all or certain sections of the website hosted by the web server computer. In that case, the end-user is given the opportunity to become a member of the website. To become a member, the end-user may have to explicitly agree to a license agreement requiring the end-user to keep certain items in the client computer, to receive advertisements from various sources, or both. For example, the end-user may be required to click on a license agreement to explicitly agree to receive advertisements in exchange for access privileges. Making the end-user explicitly agree to receive advertisements (as opposed to just displaying advertisements to the end-user) advantageously helps prevent confusion as to the source of advertisements, and also helps ensure that the end-user understands the conditions for having access privileges in the Website.

Note that in the context of the present disclosure, “receiving a cookie” is the same as receiving the contents of the cookie. That is, a web server computer does not necessarily have to receive a file comprising a cookie.

In steps 306 and 308, the client computer is denied access to the web server computer (or sections of the web server computer) if the end-user does not want to become a member. In steps 306, 310, and 312, a subscription manager is downloaded to the client computer along with a site information file for the web server computer if the end-user agrees to become a member.

Continuing in step 314, the web server computer examines the contents of the cookie to determine if the client computer has access privileges. A cookie not containing expected information (e.g., missing a pass-code, such as “SitePassMgr”) indicates that the cookie is not authentic, or is not for purposes of gaining access to the web server computer. In that case, the end-user may be asked to sign up for membership to receive a subscription manager and a site information file, as indicated in steps 320, 324, and 326. In steps 320 and 322, the client computer is denied access if the end-user does not want to become a member.

In steps 316 and 318, the client computer is allowed access to the web server computer commensurate with the client computer's access privileges.

In method 300, the site information file is obtained from the web server computer after the end-user signs up for membership. It is to be noted, however, that site information files may also be obtained from a message server computer or another web server computer. For example, referring back to FIG. 1, the end-user of client computer 110 may download subscription manager 114 and site information file 116B from message server computer 103 to gain access to a website hosted by web server computer 102B. Thereafter, the end-user may gain access privileges in a website hosted by web server computer 102A by downloading site information file 116A from message server computer 103 without having to download another subscription manager 114. As can be appreciated, once subscription manager 114 is downloaded to client computer 110, the end-user merely has to download additional site information files 116 to obtain access privileges in other websites.

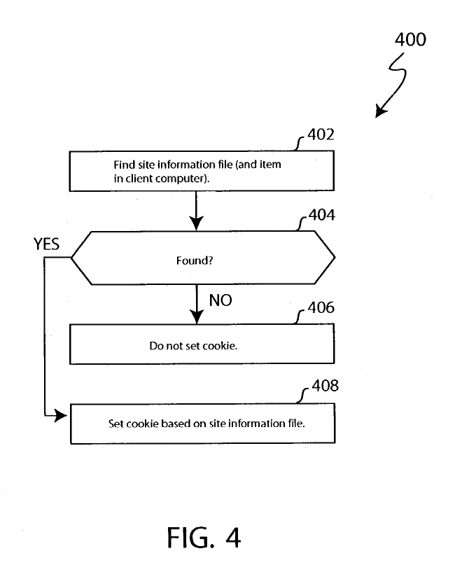

FIG. 4 shows a flow diagram of a method 400 for setting an access indicator, in accordance with an embodiment of the present invention. In embodiments disclosed herein, cookies are employed as access indicators. As can be appreciated by those of ordinary skill in the art reading the present disclosure, however, other types of files or mechanisms for holding data may also be employed in lieu of cookies. Starting in step 402, a subscription manager finds a site information file and, optionally, one or more required items in a client computer. In steps 404 and 406, a cookie serving as an access indicator for, accessing a web server computer is not set if a corresponding site information file and the required item are not found in the client computer. Not setting a cookie may include not creating a cookie if it does not exist in the first place, or not updating a pre-existing cookie. Otherwise, as indicated in steps 404 and 408, a cookie is set based on configuration information contained in the site information file. Setting a cookie may include creating a cookie if it does not exist, or updating a pre-existing cookie. In one embodiment, a cookie is set by having a client program (e.g., subscription manager 114) request a web browser to do so.

While specific embodiments of the present invention have been provided, it is to be understood that these embodiments are for illustration purposes and not limiting. Many additional embodiments will be apparent to persons of ordinary skill in the art reading this disclosure.

What is claimed is:

1. A method to be performed in a client computer, the method comprising:
setting a first access indicator in a client computer if the client computer satisfies a requirement;
providing a content of the first access indicator to a first server computer in communication with the client computer over a computer network; and
based on the content of the first access indicator, accessing a content of the first server computer.

2. The method of claim 2 wherein the first server computer comprises a website and the computer network includes the Internet.

3. The method of claim 2 wherein the first access indicator is set by a web browser in response to a request by a computer program resident in the client computer.

4. The method of claim 1 further comprising:
receiving a configuration information in the client computer, and wherein the first access indicator is set according to the configuration information.

5. The method of claim 4 wherein the configuration information is in a file received from a second server computer.

6. The method of claim 1 wherein the requirement includes having a particular item in the client computer.

7. The method of claim 6 wherein the particular item comprises a particular computer program.

8. The method of claim 7 wherein the particular computer program includes computer-readable program code for receiving advertisements in the client computer.

9. The method of claim 6 wherein the particular item comprises a file.

10. The method of claim 1 further comprising:
receiving an advertisement in the client computer if the client computer satisfies the requirement.

11. The method of claim 10 wherein the advertisement is incorporated in a web page received from the first server computer.

12. The method of claim 10 wherein the advertisement is received from a second server computer in response to a request initiated by a message delivery program resident in the client computer.

13. The method of claim 1 further comprising:
setting a second access indicator in the client computer, the second access indicator being configured to allow access to a content in a second server computer.

14. The method of claim 1 wherein the content of the first server computer comprises a web page.

15. The method of claim 1 wherein the content of the first server computer comprises an on-line service.

16. A computer-readable storage medium comprising:
computer-readable program code for determining if a client computer includes a particular item;
computer-readable program code for setting an access indicator if the client computer has the particular item;
computer-readable program code for providing a content of the access indicator to a server computer in communication with the client computer over a computer network; and
computer-readable program code for accessing a content of the server computer.

17. The computer-readable storage medium of claim 16 wherein the medium comprises computer memory.

18. The computer-readable storage medium of claim 16 wherein the medium comprises a removable storage medium.

19. The computer-readable storage medium of claim 16 wherein the medium comprises a mass storage device.

20. The computer-readable storage medium of claim 16 wherein the particular item comprises a computer program.

21. The computer-readable storage medium of claim 16 wherein the particular item comprises a file.

22. A method to be performed in a server computer, the method comprising:
receiving a content of an access indicator from a first client computer program in a client computer, the access indicator being set in response to a request by a second client computer program in the client computer; and
depending on the content of the access indicator, allowing the client computer to receive a document.

23. The method of claim 22 wherein the document comprises multi-media data.

24. The method of claim 22 wherein the document comprises a web page.

25. The method of claim 22 wherein the first client computer program comprises a web browser and the access indicator comprises a cookie.

26. The method of claim 22 wherein the access indicator is periodically set if the second client computer program detects that the client computer satisfies a requirement.

27. The method of claim 26 wherein the requirement includes having a particular computer program.

28. A server computer having a memory and a processor for running computer-readable program code resident in the memory, wherein the memory comprises:
computer-readable program code for receiving a content of a cookie from a client computer, a setting of the cookie being initiated by a non-web browser computer program resident in the client computer; and
computer-readable program code for allowing a web browser resident in the client computer to receive a web page in the client computer depending on a content of the cookie.

29. A client computer having a memory and a processor for running computer-readable program code resident in the memory, wherein the memory comprises:
computer-readable program code for detecting if a client computer includes a particular computer file;
computer-readable program code for setting a first cookie if the client computer includes the particular computer file; and
computer-readable program code for providing the first cookie to a first server computer.

30. The client computer of claim 29 wherein the particular computer file comprises a particular computer program.

31. The client computer of claim 29 wherein the particular computer file comprises a multi-media file.

32. The client computer of claim 29 wherein the memory further comprises:
computer-readable program code for setting a second cookie configured to provide the client computer access to a second server computer.

33. The client computer of claim 29 wherein the memory further comprises:
computer-readable program code for initiating delivery of advertisements from a second server computer.

34. A method of controlling access to a website, the method comprising:
making an end-user explicitly agree to receive advertisements in exchange for access privileges in a website.

35. The method of claim 34 wherein the advertisements are not from the website.

36. The method of claim 34 wherein the advertisements are from a computer program resident in a client computer employed by the end-user.

37. The method of claim 34 wherein the access privileges are indicated in a cookie.

38. The method of claim 34 wherein making the end-user explicitly agree to receive advertisements includes making the end-user click on a license agreement.

39. The method of claim 34 wherein the access privileges include permission to view a web page.

40. The method of claim 34 wherein the access privileges include permission to use an on-line service.

41. The method of claim 34 wherein the access privileges include permission to download a file.
